(19) United States
(12) Patent Application Publication
(10) Pub. No.: US 2026/0037198 A1
(43) Pub. Date: Feb. 5, 2026

(54) METHODS AND SYSTEM FOR TRACKING PRODUCTIVITY OF A PRINTING DEVICE

(71) Applicant: Kyocera Document Solutions Inc., Osaka (JP)

(72) Inventor: Javier A. MORALES, Rochester, NY (US)

(73) Assignee: Kyocera Document Solutions Inc., Osaka (JP)

(21) Appl. No.: 18/788,910

(22) Filed: Jul. 30, 2024

(51) Int. Cl. G06F 3/12

(52) U.S. Cl. CPC G06F 3/1259; G06F 3/1203

(57) ABSTRACT

A printing system includes at least one printing device. A print job is received at the printing device, which performs printing operations. The print engine of the printing device is detected as not printing. The delay caused by not printing is determined using a sensor related to a component in the printing device. The cause of the delay is categorized as an equipment issue or an operator issue. The delays are compiled after completion of the print job. An actual production time for completing the print job is determined including the compiled time delays. The actual production time is used to analyze the efficiency of the printing device.

### FIELD OF THE INVENTION

The present invention relates to methods and a system for tracking productivity during printing operations at a printing device. More particularly, the present invention relates to methods and a system to determine the cause of delays at a printing device to track productivity.

### DESCRIPTION OF THE RELATED ART

Printing devices used for production printing essentially are manufacturing devices. Unlike other classes of manufacturing devices, however, the productivity of a production printing device may be dependent on a press operator. Print shops sell press capacity to their customers. If that is not used efficiently, then the print shop may sell capacity beyond what is available. In addition, if print jobs take longer to produce versus estimates, then the print jobs and presses may not be as profitable as expected.

### SUMMARY OF THE INVENTION

A method for tracking productivity of a printing device is disclosed. The method includes performing printing operations to print a print job at the printing device. The method also includes detecting a print engine of the printing device is not printing. The method also includes determining a cause of a time delay at the print engine using at least one sensor. The cause of the time delay relates to a component of the printing device. The method also includes categorizing the cause of the time delay as an equipment issue or an operator issue based on the component. The method also includes processing the print job to complete the printing operations at the printing device. The method also includes aggregating a compiled time delay related to an equipment issue and a compiled time delay related to an operator issue. The method also includes determining an actual production time for the print job. The actual production time includes the compiled time delay related to an equipment issue and a compiled time delay related to an operator issue. The method also includes comparing the actual production time to an estimated production time for the print job. The method also includes alerting an operator based on the comparison.

A method for managing printing operations is disclosed. The method includes performing printing operations to print a print job at the printing device. The method also includes detecting a print engine of the printing device is not printing. The method also includes determining a cause of a time delay at the print engine using at least one sensor. The cause of the time delay relates to a component of the printing device. The method also includes aggregating the time delay with an actual production time for the print job. The method also includes processing the print job to complete the printing operations at the printing device. The method also includes determining an efficiency for the print job based on the actual production time to an estimated production time for the print job. The method also includes compiling the efficiency for the print job based on the actual production time to an estimated production time for the print job. The method also includes determining that the overall efficiency for the time period at the printing device falls below an efficiency threshold for the printing device. The method also includes alerting an operator that the overall efficiency for the printing device is below the efficiency threshold.

A printing system is disclosed. The printing system includes a processor. The printing system also includes a memory coupled to the processor. The memory includes instructions that, when executed on the processor, configures the printing system to perform the operations of performing printing operations to print a print job at a printing device. The operations also include detecting a print engine of the printing device is not printing. The operations also include determining a cause of a time delay at the print engine using at least one sensor. The cause of the time delay relates to a component of the printing device. The operations also include categorizing the cause of the time delay as an equipment issue or an operator issue based on the component. The operations also include processing the print job to complete printing operations at the printing device. The operations also include aggregating a compiled time delay related to an equipment issue and a compiled time delay related to an operator issue. The operations also include determining an actual production time for the print job. The actual production time includes the compiled time delay related to an equipment issue and the compiled time delay related to an operator issue. The operations also include comparing the actual production time to an estimated production time for the print job. The operations also include alerting an operator based on the comparison.

### BRIEF DESCRIPTION OF THE DRAWINGS

Various other features and attendant advantages of the present invention will be more fully appreciated when considered in conjunction with the accompanying drawings.

FIG. 1 illustrates a block diagram of a printing system having a print time estimation model according to the disclosed embodiments.

FIG. 2 illustrates a block diagram of components of a printing device according to the disclosed embodiments.

FIG. 3 illustrates a schematic diagram of a printing device for printing documents according to the disclosed embodiments.

FIG. 4 illustrates a plan view of a recording unit according to the disclosed embodiments.

FIG. 5 illustrates a configuration around the conveying path of the paper from a paper feed cassette to a second conveying unit via a first conveying unit according to the disclosed embodiments.

FIG. 6 illustrates a block diagram showing a hardware configuration of a main part of the printing device according to the disclosed embodiments.

FIG. 7 illustrates a block diagram of a supervised learning pipeline for the print time estimation model according to the disclosed embodiments.

FIG. 8 illustrates a block diagram of an example neural network topology for the print time estimation model according to the disclosed embodiments.

FIG. 9 illustrates a block diagram of components within the first printing device for use in tracking productivity of a printing device according to the disclosed embodiments.

FIG. 10 illustrates a block diagram of processing and responding to time delays during printing operations according to the disclosed embodiments.

FIG. 11 illustrates a flowchart for tracking productivity of the printing device according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a printing system that tracks actual versus ideal productivity for all jobs produced at a printing device. This information may be used through every aspect of the printing system. It is desirable for print shops to understand the actual productivity of a printing device. Because that productivity is variable due to a number of factors, the productivity should ideally be tracked at a granular level.

When a print job is received, the printing system will estimate the idealized production time for that print job. In some embodiments, the estimated print time may be provided by trained neural network. The printing system will track actual production time for the print job. The printing system will track active printing time versus times when production pauses for the print job. The information for the active printing time may be tracked separately and may be fed back into a machine language, or neural network, model.

The information about pauses in production may be tracked in two general categories. One category may be delays due to equipment issues, such as production pauses to clear jams. Another category may be delays due to operator issues, such as production pauses due to missing paper or a full output bin. Other categories may be generated. All non-production statuses are mapped into one of the above categories.

Once this information is known for the print job, the printing system will report that information to the operator in a number of ways. For example, if the print job is actively printing, then the printing system may display according to the following conditions. If the print job is managed in a calendar view, then the appearance of the appointment may change based on the production status category. An appearance of a timer may occur within the appointment for the time that the print job is at a specific state.

Regardless of how the print job is displayed, the printing system also will report the production time versus the idealized production time. For example, the print job may be displayed using a list, calendar, Gantt chart, and the like. For example, if the print job is estimated to take 60 minutes to print and the printing device is paused for the last 10 minutes, then the printing system will report the production time as 117% versus the idealized production time. Alternatively, the printing system may report 85% efficiency for the print job.

The printing system will aggregate all the job efficiency information and present it to the operator in a number of ways. When using a calendar view, the operator may specify hours that represent various work shifts. The efficiency information may be aggregated for each shift in order to give a sense of overall productivity for the shift in realtime. The aggregated efficiency information may be collected in metrics. These metrics may be persistently collected in a production dashboard. The printing system may report aggregated efficiency for work shifts, individual printing devices, individual operators, customers, customer projects, specific papers, or paper groups, specific inline finishing operations, and the like.

Further, the printing system may offer notifications when certain thresholds are exceeded. For example, the printing system may send notifications when inefficiency for the day rises above a certain threshold or when efficiency falls below a certain threshold. This feature may be narrowed to inefficiency driven by the printing device versus the operator.

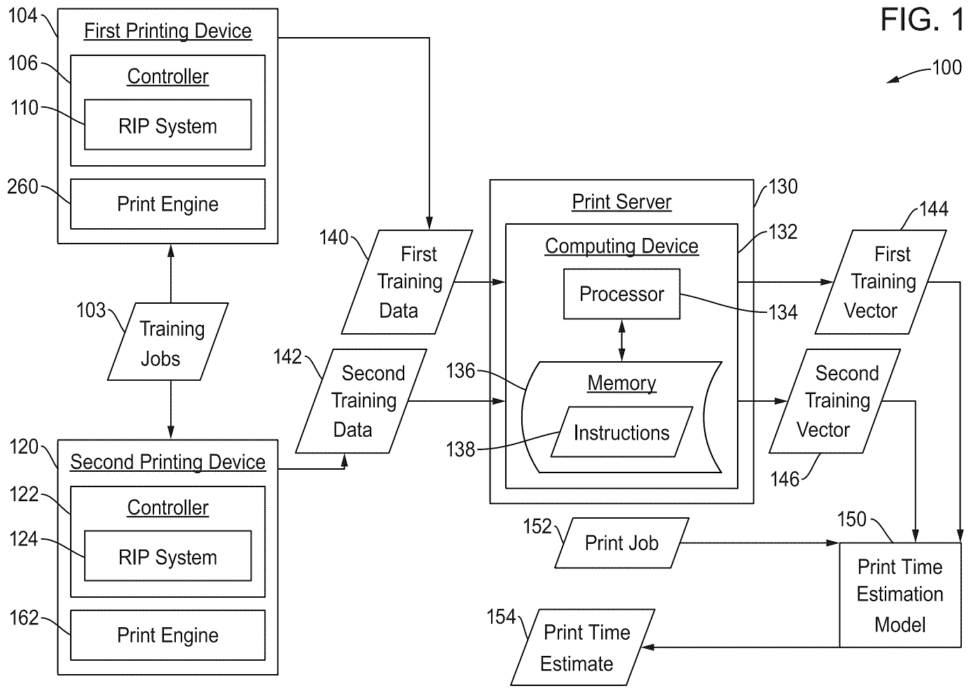

FIG. 1 depicts a block diagram of a printing system 100 having a print time estimation model 150 according to the disclosed embodiments. Printing system 100 includes first printing device 104 and second printing device 120. Printing system 100 may include additional printing devices but these are not shown for brevity. Printing system 100 also includes print server 130, which may manage printing operations within the printing system. In some embodiments, print server 130 is not part of printing system 100, and its functions are provided by a printing device coupled to the other printing devices within the printing system, such as printing device 104.

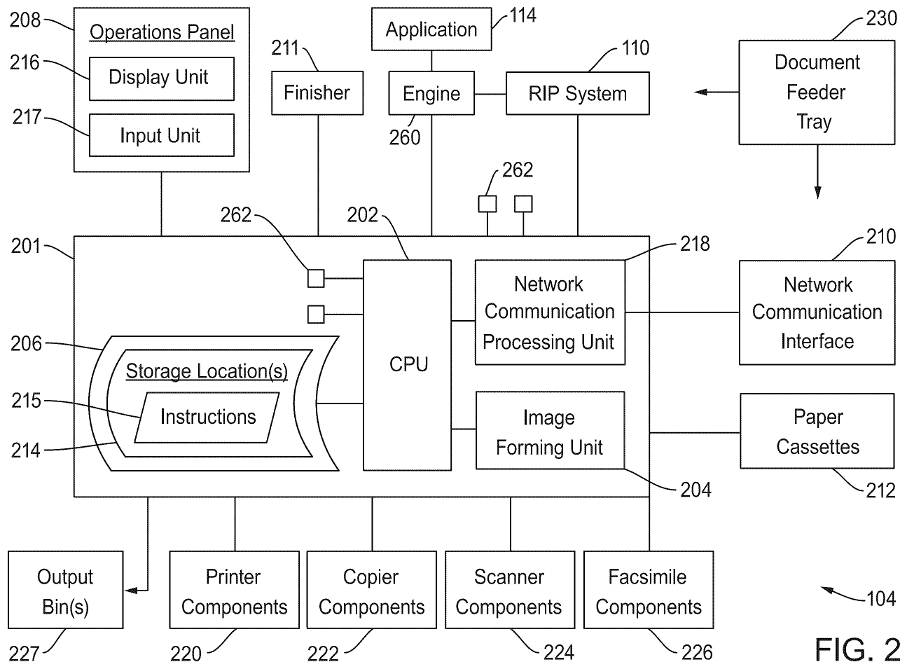

Printing device 104 receives training jobs 103 through printing system 100. In some embodiments, a training job is a print job. After processing jobs 103, printing device 104 may print or produce a document in a paper or media specified by the print job. Printing device 104 is disclosed in greater detail in FIG. 2. Printing device 104 also includes a controller, or digital front end (DFE), 106, which facilitates processing any print jobs. Controller 106 also includes RIP system 110, which is disclosed in greater detail below.

For example, controller 106 may use RIP system 110 to convert bitmap images, vector graphics, fonts, and the like associated with pages in jobs 103 to bitmap/rasterized representations of the pages, such as C, M, Y, and K pixels. The sum of the values of pixels of a particular color in the rasterized pages may be proportional to the amount of consumables used by printing device 104 to print that color. RIP system 110 may rasterize pages of jobs 103 according to various image rasterization settings. For example, these image rasterization parameters may include calibration curves, paper definitions, ICC profiles, spot color definitions, TRCs, color conversion settings, colorant limits for ink or toner, rendering intent, K preservation, CGR level, max colorant densities, print margins, halftones, and the like.

Print engine 260 also is included with printing device 104. Printing device 104 may correspond to an industrial printing device capable of printing thousands of pages in an hour. Printing device 104 may be ink-based, toner-based, or both. Print engine 260 may include various parameters that can control the operation of printing device 104. For example, these settings may include printing device maintenance settings that control or effect head cleaning intervals, head clogging prevention intervals, and the like of printing device 104. Print engine 260 receives raster output from RIP system 110 in printing device 104 to print a document based on a print job.

Second printing device 120 may perform the same functions as first printing device 104. Second printing device 120 includes controller 122 having RIP system 124. Second printing device 120 also include print engine 162. Second printing device 120 also may perform printing operations to produce documents in a production printing environment. Second printing device 120 also may receive training jobs 103. Thus, first printing device 104 and second printing device 120 may process and print the same training jobs 103. Alternatively, first printing device 104 and second printing device 120 may receive different training jobs.

Print server 130 may include a computing device 132 that includes one or more processors 134 connected to a memory 136. Memory 136 stores instructions 138 that are executed by one or more processors 134 to perform the functions disclosed herein. For example, computing device 132 may generate first training vector 144 and second training vector 146 to train print time estimation model 150. Computing device 132 receives first training data 140 from first printing device 104 and second training data 142 from second printing device 120. According to the disclosed embodiments, computing device 132 generates first training vector 144 based on first training data 140 and second training vector based on second training data 142.

To generate first training data 140, first printing device 104 processes training jobs 103. In some instances, first printing device 104 may print training jobs 103 as documents using print engine 260. Sensors and other components within printing device 104, such as controller 106, collects data as training jobs 103 are processed. Data include PDL metadata that indicates whether each job rendered at speed. Data also includes engine sensor information as well as environmental information that may impact reliability. Data also includes engine productivity information including the time that print engine 260 spends in various states, such as having the cover open.

Data collected by first printing device 104 also includes paper information including paper feed reliability. For each print job, printing device 104 may collect job metadata including print settings and print time. For example, different times of the day may include personnel that are not as efficient as another shift. Data also includes the actual print time for a print job as well as the actual waste produced while printing the job. First printing device 104 collects all this data as first training data 140 and provides it to computing device 132.

Second printing device 120 also may collect the different types of data disclosed above to generate second training data 142. The values for the types of data collected may differ from the ones produced by first printing device 104. System 100 may want to collect large amounts of training data to generate a large number of training vectors for print time estimation model 150.

Once trained, print time estimation model 150 may receive a print job 152. An operator using system 100 may desire an estimated print time for print job 152. Using features of print job 152, print time estimation model 150 predicts a print time estimate 154.

System 100 also may collect actual information as jobs are completed and use that information to train print time estimation model 150 at an ongoing basis. For example, print job 152 may be processed and printed on second printing device 120. The data generated by printing print job 152 may be used as training data back to model 150.

The disclosed embodiments also will allow an operator to make changes to the settings or parameters of print job 152 and run through print time estimation model 150 to determine different estimates for different settings. The operator then may compare which settings provides a desired or optimal print time estimate. The operate may make one or more changes to print job 152 to determine if there are any major differences in print time estimates 154 for print job 152. These changes may include assigning print job 152 to a different operator, changing the scheduled printing time, changing the paper used to print print job 152, or processing the PDL file through preflight fixups to correct potential errors. The changed print job may be used to generate an updated print time estimate 154.

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within printing system 100, such as second printing device 120. As disclosed above, printing device 104 may send and receive data from print server 103, computing device 132, if a separate device, and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays. Paper cassettes 212 may include papers having various sizes, colors, composition, and the like. Papers or media within paper cassettes 212 may be considered “loaded” onto printing device 104. The information for printing these papers may be captured in a paper catalog stored at controller 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. RIP system 100 that interprets the page description languages (PDLs) would transmit and send instructions down to the lower-level engine 260 for actual rendering of an image and application of the ink onto paper during operations on printing device 104. RIP system 110 may be located in DFE 106, as disclosed above. Alternatively, RIP system 110 may be located on print management server 108 and directly communicates with print engine 260.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code. Various sensors 262 may be disclosed in greater detail below.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Memory unit 206 may store the history of failure events and occurred errors with a timestamp of each error. Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from computing device 132 and print server 130 as well as other printing devices within printing system 100. First printing device 104 may generate and send first training data 140 in this manner.

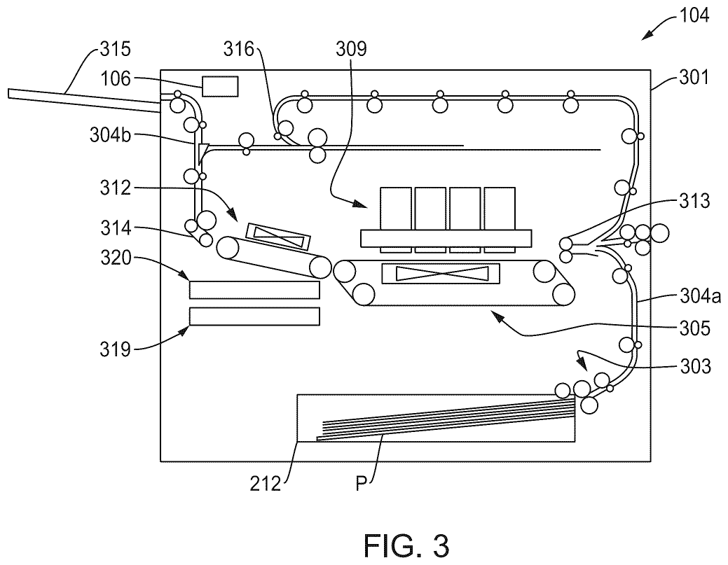

FIG. 3 depicts a schematic diagram of first printing device 104 for printing documents according to the disclosed embodiments. Second printing device 120 also may include the features disclosed herein by the schematic diagram. First printing device 104 includes a paper feed cassette 212 that is a paper storage unit. Paper feed cassette 212 may be arranged at the lower inner portion of printing device body 301. Paper P, which is an example of a recording medium, is housed inside paper feed cassette 212.

A paper feeding device 303 is arranged on the downstream side in the paper conveying direction of paper feed cassette 212, or, in other words, above the right side of paper feed cassette in FIG. 3. By this paper feeding device 303, paper P is directed toward the upper right of paper feed cassette 212 in FIG. 3, and is separated and fed out one sheet at a time.

First printing device 104 includes a first paper conveying path 304a in the inner portion thereof. First paper conveying path 304a is located on the upper right side, which is the paper feed direction, with respect to paper feed cassette 212. The paper P fed out from paper feed cassette 212 is conveyed vertically upward along the side surface of printing device body 301 by first paper conveying path 304a.

A registration roller pair 313 is provided at the downstream end of first paper conveying path 304a in the paper conveying direction. Further, a first conveying unit 305 and a recording unit 309 are arranged immediately downstream of registration roller pair 313 in the paper conveying direction. The paper P fed out from paper feed cassette 212 reaches registration roller pair 313 via first paper conveying path 304a. Registration roller pair 313 feeds the paper P toward first conveying unit 305 while correcting diagonal feeding of the paper P and measuring the timing with the ink ejection operation performed by recording unit 309.

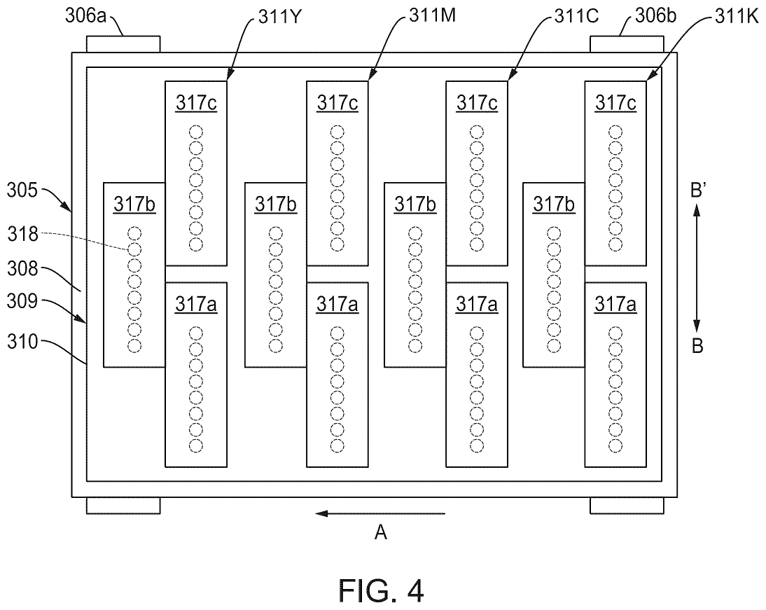

The paper P fed to first conveying unit 305 is conveyed to a position facing recording unit 309, especially recording heads 317a, 317b, and 317c, disclosed below, by a first conveyor belt 308, shown in FIG. 4. An image is recorded on the paper P by ejecting ink from recording unit 309 onto the paper P. At this time, the ejection of ink in recording unit 309 is controlled by controller 106 in the inner portion of first printing device 104. Controller 106 includes, for example, a central processing unit (CPU). Controller 106 also may be known as a digital front end (DFE) for first printing device 104.

Second conveying unit 312 is arranged on the downstream side, or left side in FIG. 3, of first conveying unit 305 in the paper conveying direction. The paper P on which the image is recorded by recording unit 309 is sent to second conveying unit 312. The ink ejected onto the surface of the paper P is dried while passing through second conveying unit 312.

A decurler unit 314 is provided on the downstream side of second conveying unit 312 in the paper conveying direction and near the left side surface of printing device body 301. The paper P whose ink has been dried by second conveying unit 312 is sent to decurler unit 314 in order to correct curling that has occurred in the paper P.

A second paper conveying path 304b is provided on the downstream side, or upper side in FIG. 3, of decurler unit 314 in the paper conveying direction. In a case where double-sided recording is not performed, the paper P that has passed through decurler unit 314 passes through second paper conveying path 304b and is discharged to paper discharge tray 315 provided in the outer portion of the left side surface of first printing device 104. Paper discharge tray 315 corresponds to one or more output bins 227 shown in FIG. 2.

A reverse conveying path 316 for performing double-sided recording is provided in the upper portion of printing device body 301 above recording unit 309 and second conveying unit 312. In a case of performing double-sided recording, the paper P that has passed through second conveying unit 312 and decurler unit 314 after recording on one surface, or the first surface, of the paper P is sent to reverse conveying path 316 through second paper conveying path 304b.

The conveying direction of the paper P sent to reverse conveying path 316 is subsequently switched for recording on the other surface, or the second surface, of the paper P. Then, the paper P passes through the upper portion of printing device body 301 and is sent toward the right side, and is sent again, via registration roller pair 313, to first conveying unit 305 with the second surface thereof facing upward. In first conveying unit 305, the paper P is conveyed to a position facing recording unit 309, and an image is recorded on the second surface by ejecting ink from recording unit 309. The paper P, after double-sided recording, is discharged to paper discharge tray 315 via second conveying unit 312, decurler unit 314, and second paper conveying path 304b, in this order.

Moreover, a maintenance unit 319 and a cap unit 320 are arranged below second conveying unit 312. When executing purging, maintenance unit 319 moves horizontally below recording unit 309, wipes the ink extruded from the ink ejection port of the recording head, and collects the wiped ink. Note that purging refers to an operation of forcibly extruding the ink from the ink ejection port of the recording head in order to discharge thickened ink, foreign matter, and air bubbles in the ink ejection port. Cap unit 320 moves horizontally below recording unit 309 when capping the ink ejection surface of the recording head, moves further upward, and is attached to the lower surface of the recording head. Controller 106 may determine the amount of ink used for purging operations using a sensor 262 located in the vicinity of maintenance unit 319 and cap unit 320

FIG. 4 depicts a plan view of recording unit 309 according to the disclosed embodiments. Recording unit 309 includes a head housing 310 and line heads 311Y, 311M, 311C, and 311K. Line heads 311Y to 311K are held in head housing 310 at a height at which specific spacing, for example 1 mm, is formed with respect to the conveying surface of an endless first conveyor belt 308 that spans around a plurality of rollers including a drive roller 306a, a follower roller 306b, and another roller 307.

Line heads 311Y to 311K have a plurality of recording heads 317a, 317b, and 317c, respectively. Recording heads 317a to 317c are arranged in a zigzag pattern along the paper width direction (direction of arrow BB′) orthogonal to the paper conveying direction (direction of arrow A). Recording heads 317a to 317c have a plurality of ink ejection ports 318 (nozzles). Each ink ejection ports 318 are arranged side by side at equal intervals in the width direction of the recording head, or in other words, the paper width direction (direction of arrow BB′). From line heads 311Y to 311K, ink of each color of yellow (Y), magenta (M), cyan (C), and black (K) is respectively ejected via ink ejection ports 318 of recording heads 317a to 317c toward the paper P that is conveyed by first conveyor belt 308.

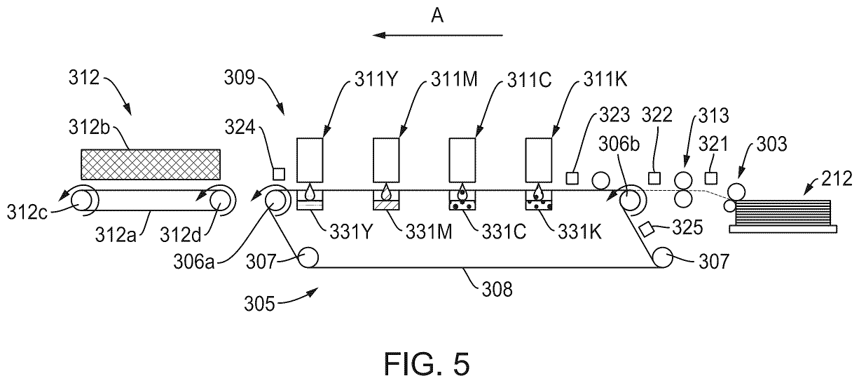

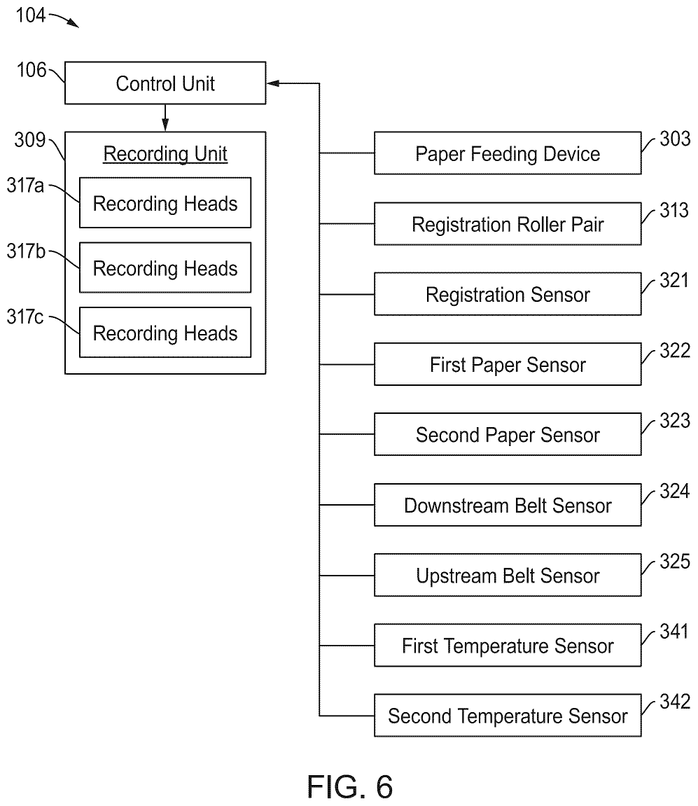

FIG. 5 depicts a configuration around the conveying path of the paper P from paper feed cassette 212 to second conveying unit 312 via first conveying unit 305 according to the disclosed embodiments. FIG. 6 depicts a block diagram showing a hardware configuration of a main part of first printing device 104 according to the disclosed embodiments. First printing device 104, in addition to the configuration disclosed above, further includes a registration sensor 321, a first paper sensor 322, a second paper sensor 323, belt sensors 324 and 325, first temperature sensor 341, and second temperature sensor 342.

Registration sensor 321 detects the paper P conveyed from paper feed cassette 212 by paper feeding device 303 and sent to registration roller pair 313. Controller 106 is able to control the rotation start timing of registration roller pair 313 based on the detection result of registration sensor 321. For example, controller 106 is able to control the supply timing of paper P after the skew (inclination) correction by registration roller pair 313 to first conveyor belt 308 based on the detection result of registration sensor 321.

First paper sensor 322 is a line sensor that detects the position in the width direction of the paper P sent from registration roller pair 313 to first conveyor belt 308. Based on the detection result of first paper sensor 322, controller 106 is able to record an image on the paper P by causing ink to be ejected from ink ejection openings 318 of the ink ejection ports of recording heads 317a to 317c of line heads 311Y to 311K that correspond to the width of the paper P.

Second paper sensor 323 is a sensor for detecting the position in the conveying direction of the paper P conveyed by first conveyor belt 308. Second paper sensor 323 is located on the upstream side in the paper conveying direction of recording unit 309 and on the downstream side of first paper sensor 322. Based on the detection result of second paper sensor 323, controller 106 is able to control the ink ejection timing for the paper P reaching the position facing line heads 311y to 311K, and recording heads 317a to 317c, by first conveyor belt 308.

Belt sensors 324 and 325 detect the positions of a plurality of opening portion groups provided on first conveyor belt 308. Belt sensors 324 and 325 are detection sensors that detect the passage of at least one of the opening groups due to the running of first conveyor belt 308. Belt sensor 324 is located on the downstream side of recording unit 309 in the paper conveying direction, or the running direction of first conveyor belt 308. Belt sensor 325 is located at a position between follower roller 306b and other roller 307 where first conveyor belt 308 is stretched around follower roller 306b and other roller 307. Follower roller 306b is located on the upstream side of recording unit 309 in the running direction of first conveyor belt 308. Note that belt sensor 324 also has the same function as second paper sensor 323. Controller 106 is able to control registration roller pair 13 so as to supply paper P to first conveyor belt 308 at a specific timing based on the detection result of belt sensor 324 or 325.

The positions of the paper P are detected by a plurality of sensors (second paper sensor 323 and belt sensor 324), and the positions of the opening portion groups of first conveyor belt 308 are detected by a plurality of sensors (belt sensors 324 and 325), and, as a result, it is possible to correct errors in the detected positions and detect an abnormality.

First paper sensor 322, second paper sensor 323, and belt sensors 324 and 325 disclosed above may be configured by a CIS sensor. Marks corresponding to the position of opening portion groups are formed at the end portion in the width direction of first conveyor belt 308 and belt sensors 324 and 325 detect the marks, whereby the positions of the opening portion groups may be detected. CIS sensors may be image sensors that are almost in direct contact with the object to be scanned. A CIS sensor typically includes a linear array of detectors, covered by focusing lenses and flanked by red, green, and blue light emitting diodes (LEDs) for illumination.

First temperature sensor 341 is a sensor that detects the ambient temperature of first printing device 104, and includes, for example, a non-contact temperature sensor such as a radiation thermometer or the like, and is provided on the outer surface of printing device main body 301. Second temperature sensor 342 is a sensor that detects the temperature of recording heads 317a to 317c, and includes, for example, a contact type temperature sensor such as a thermistor, a resistance temperature detector, a thermocouple, and the like. Controller 106 can control the amount of ink ejected from each ink ejection port 318 of recording heads 317a to 317c based on the detection result of first temperature sensor 341 or second temperature sensor 342.

Referring to FIG. 5, first printing device 104 has ink receiving units 331Y, 331M, 331C, and 331K on the inner peripheral surface side of first conveyor belt 308. When recording heads 317a to 317c are made to execute flushing, ink receiving units 331Y to 331K receive and collect the ink that has been ejected from recording heads 317a to 317c and passed through the opening portions of opening portion groups of first conveyor belt 308. Ink receiving units 331Y to 331K are provided at positions facing recording heads 317a to 317c of line heads 311Y to 311K via first conveyor belt 308. The ink collected by ink receiving units 331Y to 331K is sent to, for example, a waste ink tank and disposed of, however, also may be reused without being disposed of.

Flushing is the ejection of the ink at a timing different from the timing that contributes to image formation or recording on the paper P, and is for the purpose of reducing or preventing clogging of ink ejection ports 318 due to ink drying. The execution of flushing in the recording heads 317a to 317c is controlled by controller 106. Second conveying unit 312 is configured to include a second conveyor belt 312a and a dryer 312b. Second conveyor belt 312a is stretched around two drive rollers 312c and a follower roller 312d. The paper P that is conveyed by first conveying unit 305 and on which an image has been recorded by ink ejected by recording unit 309 is conveyed by second conveyor belt 312a and dried by dryer 312b while being conveyed to decurler unit 314.

It may be appreciated that the above embodiments disclose an inkjet printing device. The disclosed embodiments, however, also may apply to toner and laser printing devices that implement sensors to track printing operations and use of consumables, such as ink, toner, sheets, staples, and the like. Further, such printing devices also include a controller to manage printing operations and a print engine to print sheets. In summary, such printing devices include sensors and systems to collect data about printing operations for training jobs 103.

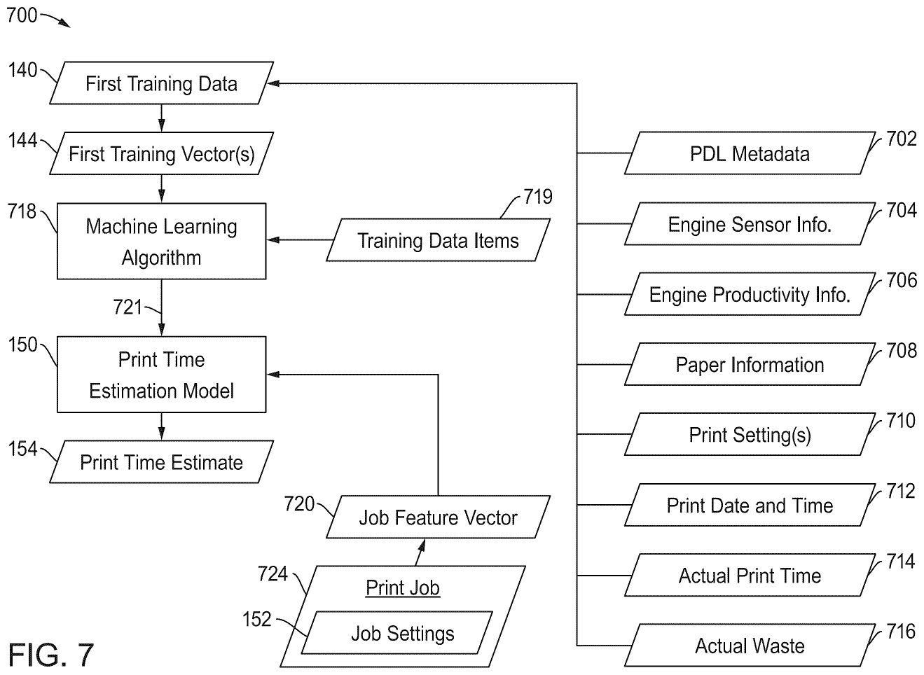

FIG. 7 depicts a block diagram of a supervised learning pipeline 700 for print time estimation model 150 according to the disclosed embodiments. Supervised learning pipeline 700 includes first training data 140, first training vector 144, machine learning algorithm 718, print job 152, job feature vector 720, and print time estimation model 150 that products one or more print time estimates 154. Part or all of supervised learning pipeline 700 may be implemented by executing software for part or all of supervised learning pipeline 700 on one or more processors 134 or other components within computing device 132 or print server 130.

In operation, supervised learning pipeline may involve two phases: a training phase and a prediction phase. The training phase may involve machine learning algorithm 718 learning one or more tasks related to estimating a print time for a print job at a printing device or within printing system 100. The prediction phase may include print time estimation model 150, which is a trained version of machine learning algorithm 718 and makes predictions to accomplish one or more tasks for estimating print time. In some embodiments, machine learning algorithm 718 or print time estimation model 150 may include one or more artificial neural networks (ANNs), deep neural networks, convolutional neural networks (CNNs), recurrent neural networks (RNNs), support vector machines (SVMs), Bayesian networks, genetic algorithms, linear classifiers, non-linear classifiers, algorithms based on kernel methods, logistic regression algorithms, linear discriminant analysis algorithms, or principal components analysis algorithms.

During the training phase of supervised learning pipeline 700, training jobs 103 may be received at first printing device 104. Training jobs 103 may be actual print jobs received within printing system 100. Alternatively, training jobs 103 may be jobs generated within printing system 100 to produce training data. For example, training jobs 103 may include a variety of different print jobs having different job settings to generate data for the different types of print jobs. First training data 140 may be processed to determine one or more first training vectors 144. In some embodiments, first training data 140 may be preprocessed.

In some embodiments, some or all of first training data 140 includes PDL metadata 702, engine sensor information 704, engine productivity information 706, paper information 708, print setting or settings 710, print data and time 712, actual print time 714, and actual waste 716. Additional data may be compiled by one or more sensors in printing device 104 disclosed above. The different types of data for first training data 140 may be disclosed in greater detail below. These different types of data may be generated for each print job of training jobs 103.

PDL metadata 702 may refer to the speed at which each page was rendered for a print job. PDL metadata 702 may be dependent on print speed of print engine 260 and complexity of the page or pages in the print job. For example, if a page is “complex” then it will take longer to process and print than a “simple” page. The definition for a complex page may vary. For example, a page may be complex if it includes a data objects, spot colors, different images, transparent objects, and the like. The act of rendering the page will take longer and use more resources than normal. As the page is rendered, controller 106 may determine that it is not printing at speed with print engine 260 such that printing the page takes longer than normal.

Engine sensor information 704 may refer to information detected by sensors within first printing device, such as first temperature sensor 341 and second temperature sensor 342. Additional sensors may be included that determine altitude, humidity, and other environmental conditions for first printing device 104. Sensors 341 and 342 may be configured to detect these values for the conditions of first printing device 104.

Engine productivity information 706 may refer to information about the time print engine 260 spends in various states of operation. These states may include states of the printing device, such as a cover being open, replacement of a paper cassette 212, removal of an output bin 227, removal of a paper jam, and the like. This information also may include the name of the operator, the customer or sender of the print job, location within the print shop, and other information. This information may be collected by controller 106.

Paper information 708 may refer to information about the paper used in the print job. Paper information 708 may include size, texture, finish, color, and the like. This information may be collected by controller 106. It also may include paper feeding reliability. In other words, how easy or reliable the paper may be fed into first printing device as disclosed above without jams. It also may include how many pages per minute (or some other criteria) are fed into paper feeding device 303.

Print setting or settings 710 may refer to the job settings sent with the print job. Print settings may include print condition, color print settings, print quality, and the like. These settings impact how the document is printed at first printing device 104. Print date and time 712 may refer to the date and time that the print job was processed and printed at first printing device 104. This data may take into account second shift operations, or other times where the personnel differs from other times. Print settings 710 and print date and time 712 may be known as job metadata.

Actual print time 714 may refer to the time to process and print the print job. It may include when the job is read from a queue and rendered then sent to print engine 260. In some embodiments, these discrete tasks also may be timed so that controller 106 compiles the time data for different tasks. Actual waste 716 may refer to the actual waste produced while printing the job, such as paper jams, maintenance, and the like. Waste may refer to consumables.

All of the types of data and information disclosed above may be compiled into first training data 140. First training vector 144 may be generated to transform the raw data of first training date 140 into a structured format that can be used to train print time estimation model 150. First training data 140 may be structured data in a tabular format or unstructured data such as text date or a document. The disclosed embodiments may preprocess the data by normalization/standardization, encoding categorical data, handling missing values for data, feature selection/extraction, tokenization, stop-word removal, stemming/lemmatization, feature extraction, and the like. After preprocessing, features may be combined to ensure compatibility and merged into the final feature vector.

First training vector 144 may be provided to machine learning algorithm 718 to learn one or more tasks for predicting or estimating a print time for a print job. After performing the one or more tasks, machine learning algorithm 718 may generate one or more outputs 721 based on first training vector 144, and, optionally, training data items 719. During training, training data items 719 may be used to make an assessment of outputs 721 for accuracy. Machine learning algorithm 718 may be updated based on this assessment. Training of machine learning algorithm 718 is considered to be trained to perform the one or more tasks for estimating a print time for a print job. Once trained, machine learning algorithm 718 may be considered to be print time estimation model 150. In other words, print time estimation model 150 may be generated from the training of machine learning algorithm 718. In some embodiments, machine learning algorithm 718 is known as a model.

During the prediction phase of supervised learning pipeline 700, print job 152 may be used to generate one or more job feature vectors 720. In some embodiments, print job 152 includes job settings 724, print ticket settings, and the like to specify how a document is to be printed. Job settings 724 may include the number of pages, color print settings, print conditions, finishing operations, and the like. Other information may include the time of day for print job 152 to be printed and other information. Environmental information, such as temperature, altitude, humidity, and the like also may be included.

Print job 152 is provided to print time estimation model 150 as job feature vector 720. Job feature vector 720 may include the data of print job 152 processed into a vector, similar to first training vector 144. In other embodiments, the actual document may be inputted into the model. Using the trained model, a print time estimate 154 is provided for print job 152.

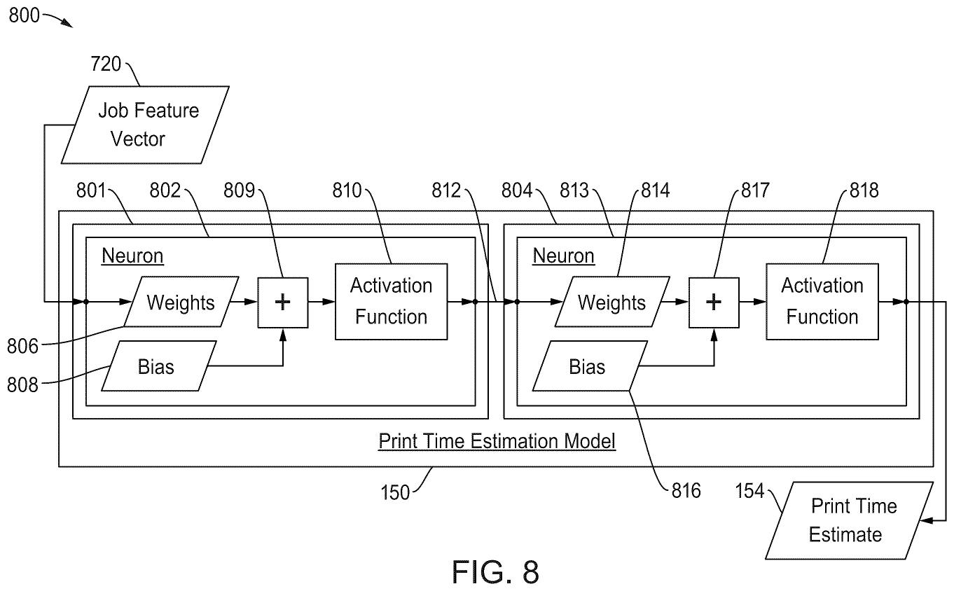

FIG. 8 depicts a block diagram of an example neural network topology 800 for print time estimation model 150 according to the disclosed embodiments. Print time estimation model 150 may implement a number of hidden layers, a number of neurons in each layer, and a number of transfer functions. For example, model 150 may be a single layer neural network model, a two-layer neural network model, and the like may be implemented. A single layer neural network model is disclosed for brevity.

Print time estimation model 150 includes a hidden layer 801 and an output layer 804. More than one hidden layer 802 may be implemented. Hidden layer 802 includes a plurality of neurons 802. A single neuron 802 is shown in FIG. 8 for brevity, but the topology of neuron 802 may be repeated for each neuron of hidden layer 801. In some embodiments, the number of neurons 802 is 8, 14, 16, and the like.

Each neuron 802 receives job feature vector 720 to be used in estimating a print time at a printing device, such as first printing device 104, for print job 152. The values in job feature vector 720 may be fed into hidden layer 801. Weights 806 are applied to each value and summed using summation operation 809 with bias 808. Weights 806 may represent the attributes that print time estimation model 150 learns during training. In other words, weights 806 may be determined using first training data 140. Each neuron 802 may include its own sets of weights connecting it to the neurons in the previous layer or to values in job feature vector 720.

Bias 808 may be an additional attribute to shift the activation function that follows, to allow more flexibility in modeling the data. Bias 808 may be applied in each neuron 802. This feature enables print time estimation model 150 to fit the data better by adjusting the output along with the weighted sum of inputs.

After calculating the weight sum of inputs of the values, and adding bias 808, the result of summation operation 809 is passed to activation function 810. Activation function 810 also may be known as a transfer function. Activation function 810 may provide non-linearity to print time estimation model 150. In some embodiments, activation function 810 may implement a tangent sigmoid, or TANSIG, function, or a rectified linear unit, or RELU, function. Activation function 810 outputs its result to the neurons in the next hidden layer or to output layer 804.

Output layer 804 may include a single neuron 813 that receives the outputs from neurons 802 of hidden layer 801. Neuron 813 applies weights 814 to the outputs and uses summation function 817 to sum the results with bias 816. The result is provided to activation function 818, which operates like activation function 810. The output of activation function 818 of output layer is a predicted print time estimate 154. Thus, the disclosed embodiments may implement the processes disclosed above to train print time estimation model 150 to predict print times for a variety of print jobs under many different conditions.

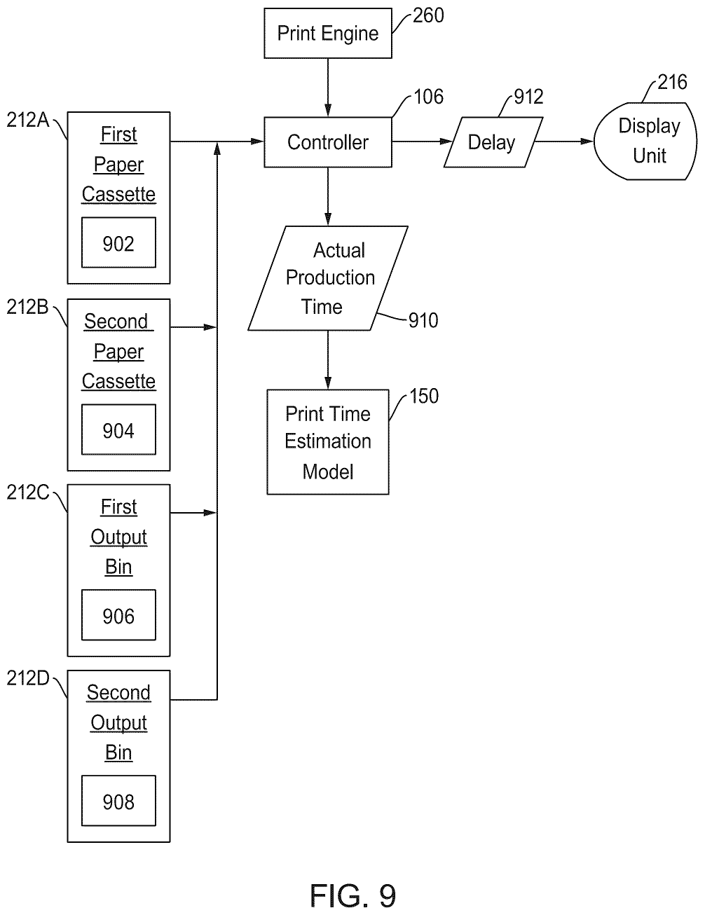

FIG. 9 depicts a block diagram of components within first printing device 104 for use in tracking productivity of a printing device according to the disclosed embodiments. The term of a printing device may refer to first printing device 104 or second printing device 120. First printing device is disclosed below for illustrative purposes. The disclosed embodiments may track productivity within a printing device to compare actual production time for a print job to print time estimate 154. The actual production time to perform printing operations for a print job 152 may be fed back to print time estimation model 150 to improve estimates for executing a print job.

Controller 106 may track the actual production time for print job 152. Alternatively, print server 130 may track the actual production time. Controller 106 tracks information about pauses in production. These pauses may be delays caused by equipment issues or operator issue. Further, print engine 260 provides data to controller 106 about the actual production time.

Equipment issues may be related to production delays to resolve a problem within first printing device 104, such as paper jams. Print engine 260 may pause printing based on some issue with a component in first printing device 104, as disclosed above. The various sensors disclosed above may determine the cause of the pause. For example, sensors 262 are used to track paper jams and other such problems encountered during printing operations. If these sensors determine printing should be paused then the delay is tracked by controller 106.

Operator issues may relate to issues that do not have anything to do with the equipment within first printing device 104. Instead, operator issues relate to pauses due to missing paper in one or more paper cassettes 212 or a full output bin 227, as disclosed in FIG. 2. In FIG. 9, first paper cassette 212A and second paper cassette 212B are shown. First output bin 227A and second output bin 227B also are shown. Sensors on these components may be used to track when the components are open or removed so that first printing device 104 may not perform printing operations.

For example, first paper cassette 212A may include sensor 902 to detects when the paper cassette is open or removed to receive more paper. A specific paper may be assigned to first paper cassette 212A such that controller 106 tracks pauses related to a specified paper type. Second paper cassette 212B also includes sensor 904 to detect when it is open or removed. Second paper cassette 212B also may be assigned a specific paper type. When one of the paper cassettes is not in operation, the respective sensor 902 or 904 informs controller 106 of the start and end of the delay. Using the example, the operator may open or remove a paper cassette to refill the paper for print jobs. Further, operator error may cause more time delays by loading the wrong paper for print job 152.

Delays due to operator issues also may be caused by output bins becoming full and needing to be emptied. First output bin 227A may include sensor 906. Second output bin 227B may include sensor 908. These sensors notify controller 106 when a pause occurs at the output bins, such as when the bins are full. An operator may empty output bins during printing operations without causing delays but, at times, may not be about to do so in a timely manner. Thus, these delays are classified as operator issues.

The delays caused by equipment or operator are compiled after the printing operations for print job 152 is complete. The compiled time delay is then added to the time to perform printing operations for print job 152. The compiled time delay provides better feedback to how productive is first printing device 104. Thus, controller 106 may determine an actual production time 910 for print job 152.

If print job 152 is actively printing during the delay, then the disclosed embodiments may report this information using a display, such as display unit 216. During a delay when print engine 260 is stopped due to an equipment issue or due to a paper cassette or output bin being open or removed, controller 106 may forward a delay instruction 912 to display unit 216. If a calendar view is being used to track printing operators, then the appearance of the appointment will change based on the production status category. Delay instruction 912 may modify the view of the calendar in display unit 216.

The disclosed embodiments also will report actual production time 910 versus print time estimate 154. For example, if print job 152 is estimated to take 60 minutes to print by print time estimate 154, then a pause of 10 minutes will result in an actual production time 910 of 70 minutes. The actual production time is 117% versus the idealized production time of 100%. Controller 106 may report this information to print server 130. Alternatively, the disclosed embodiments may report 85% efficiency for print job 152.

As may be appreciated, actual production time 910 may be provided to print time estimation model 150. The actual production time for a print job may better train the neural network model in providing print time estimates. The layers may be updated with the actual production time, even after training using first training data 140 and second training data 142.

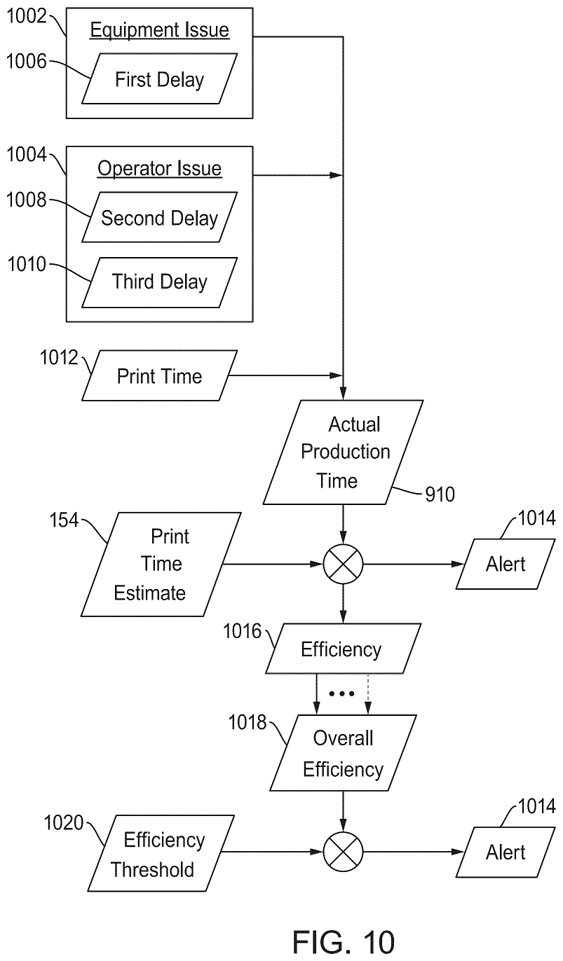

FIG. 10 depicts a block diagram of processing and responding to time delays during printing operations according to the disclosed embodiments. Regardless how a delay is treated during printing operations, the disclosed embodiments will report the production time versus the estimated production time. The disclosed embodiments also will aggregate all the job efficiency information and provide it to the operator. Further, this information may be used to take action by first printing device 104 or print server 130.

Print job 152 may be received for first printing device 104. Print job 152 is provided to print time estimation model 150 to generate print time estimate 154, which may be the predicted estimation time to complete printing operations at first printing device 104 for the print job. Print job 152 is printed at first printing device 104. One or more delays may occur during the printing operations, which are tracked by controller 106.

For example, first delay 1006 may be due to a paper jam in one of the paper paths disclosed above. A sensor captures data that a paper is jammed and pauses printing operations at print engine 260. When printing resumes, the cause of the delay may be determined and used to categorize first delay 1006 as an equipment issue 1002. Additional delays may be equipment issues and compiled in equipment issue 1002.

Other delays during printing operations for print job 152 may include second delay 1008 and third delay 1010. Second delay 1008 may relate to first paper cassette 212A being removed to fill with more paper. Third delay 1010 may relate to first output bin 227A being opened to remove printed sheets when the bin is full. Delays 1008 and 1010 may be categorized as operator issues 1004. Delays 1008 and 1010 are compiled as operator issue time delays.

The compiled time delays from each category are combined with print time 1012 to generate actual production time 910. Print time 1012 may be the total time that print engine 260 is in use for printing operations of print job 152. In some embodiments, actual production time 910 reflects that actual time that first printing device 104 spend printing the print job. It is compared to print time estimate 154 to determine if an alert 1014 should be provided. Alert 1014 may be sent to the operator that a problem occurred during printing operations for print job 152. Alert 1014 may cause the delays to be displayed in display unit 216.

Alert 1014 may notify the operator that further delays may occur within the print schedule and to be aware of such. Alert 1014 also may provide metrics collected persistently in a production dashboard displayed on display unit 216.

In some embodiments, efficiency 1016 is determined using actual production time 910 and print time estimate 154. For example, efficiency 1016 may corresponds to the print estimate time divided by the actual production time. Thus, if the print estimate time is 60 minutes and the actual production time is 80 minutes then efficiency 1016 is 60/80 or 0.75 (75%). Another parameter may be the actual production time divided by the print estimate time. Thus, this parameter may be 80/60 or 1.33 (133%). Efficiency 1016 may be determined for each print job processed on first printing device 104.

Efficiency 1016 is compiled with overall efficiency 1018 for a time period defined at first printing device 104. The disclosed embodiments may aggregate time delays and determine efficiencies for print jobs during a work shift, individual printing devices, individual operators, customers, projects, specific papers, paper groups, specific inline finishing operations, and the like. Efficiencies for these defined categories are compiled into overall efficiency 1018. For example, five print jobs may be processed and printed during a work shift. Efficiencies 1016 may be average to provide an overall average efficiency. Alternatively, overall efficiency 1018 may be the summed efficiencies.

Using the example, overall efficiency 1018 may be determined using efficiencies 1016 for the five print jobs as 1.00, 0.90, 1.00, 0.80, and 0.75. The overall efficiency for the five print jobs should be 5.00 if summed and 0.89 if averaged. These results are compared to an efficiency threshold 1020. If overall efficiency 1018 is below efficiency threshold 1020, then alert 1014 is sent to the operator.

These features allow the disclosed embodiments to track the actual production time and corresponding efficiencies of print jobs. In some embodiments, if the efficiencies for a set of print jobs show a trend upwards, then an alert also may be sent that a printing device is breaking down more frequently or needing refills more often. Thus, the actual production time determined from the categorized delays may be used to monitor printing operations at a printing device to identify when problems are occurring as well as updating print time estimation model 150.

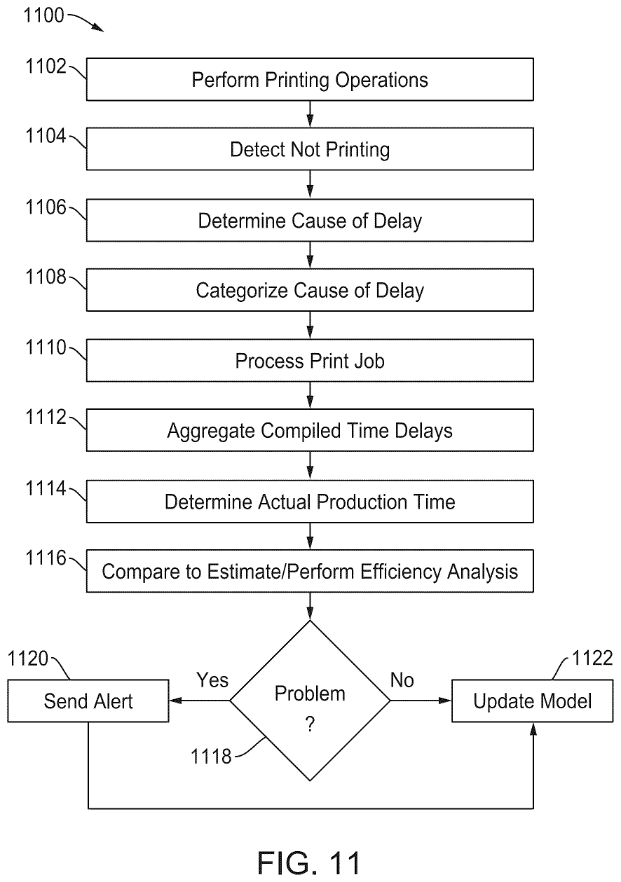

FIG. 11 depicts a flowchart 1100 for tracking productivity of first printing device 104 according to the disclosed embodiments. Flowchart 1100 may refer to FIGS. 1-10 for illustrative purposes. Flowchart 1100, however, is not limited to the embodiments disclosed by FIGS. 1-10.

Step 1102 executes by performing printing operations to process print job 152 at first printing device 104. Print job 152 may have been submitted to print time estimation model 150 to generate print time estimate 154. Print time estimate 154 may be considered an idealized or predicted print time to perform printing operations for print job 152 at first printing device 104 or within printing system 100, as disclosed above.

Step 1104 executes by detecting that print engine 260 of first printing device 104 is not printing. One or more sensors, as disclosed above, may determine that print engine 260 is not processing and printing sheets of paper for print job 152. Step 1106 executes by determining the cause of the delay at print engine 260 using one or more sensors, as disclosed above. For example, sensors 262, 321, 322, 323, 324, 325, 341, and 342 may be used to determine whether the delay is caused by the operation of first printing device 104. Sensors 902, 904, 906, and 908 may be used to determine whether the delay is caused by issues outside first printing device 104, such as removing or opening a paper cassette or output bin. The delay may relate to a component within first printing device as determined by the appropriate sensor. For example, sensors 902-908 will indicate that the delay is caused by a paper cassette or an output bin while the other sensors relate to components within first printing device 104.

Step 1108 executes by categorizing the cause of the delay as an equipment issue or operator issue based on the component. Using the above example, if the delay is caused by a paper cassette or output bin being removed, opened, or otherwise not available, then the delay may be an operator issue. If the delay is caused by an issue within first printing device 104 as detected by sensors 262, 321, 322, 323, 324, 325, 341, and 342, then the delay is due to an equipment issue.

Step 1110 executes by processing print job 152 after the delay is resolved. Printing operations resume to finish processing print job 152. More than one delay may occur. Controller 106 may track the delay or delays, and categorize them accordingly as an equipment issue or an operator issue. Step 1112 executes by aggregating compiled time delays for the specific issues. For example, one or more equipment delays may be compiled as equipment issues 1002. One or more operator delays may be compiled as operator issues 1004. Using these examples, second delay 1008 may be four minutes and third delay 1010 may be two minutes. Second delay 1008 and third delay 1010 are categorized as operator delays so they are compiled to a delay of six minutes for operator issues 1004.

Step 1114 executes by determining actual production time 910 based on the compiled time delay for equipment issues 1002 and the compiled time delay for operator issues 1004. For example, the compiled time delay for equipment issues 1002 may be four minutes based on first delay 1006 and any other additional time delays related to equipment issues. The compiled time delay for operator issues 1004 may be six minutes, as disclosed above. Actual production time 910 for printing print job 152 will include the compiled time delays.

Step 1116 executes by comparing actual production time 910 for processing print job 152 to print time estimate 154. The disclosed embodiments compare these features to determine if actual production time 910 is greater than print time estimate 154. For example, if print time estimate 154 is 60 minutes and actual production time 910 is 70 minutes based on the additional 10 minutes due to delays, then something may need to be addressed within first printing device 104 or printing system 100.

Alternatively, step 1116 may execute by performing an efficiency analysis, as disclosed above. Efficiency 1016 for print job 152 is determined. This efficiency is compiled to overall efficiency 1018 for first printing device 104. As disclosed above, efficiency 1016 may be summed or added to overall efficiency 1018. Alternatively, it may be used to recalculate an average of efficiencies of print jobs at first printing device 104. Overall efficiency 1018 is compared to efficiency threshold 1020 to determine whether any potential problems may exist.

Step 1118 executes by determining whether a potential problem exists based on the result of step 1116. For example, actual production time 910 may be greater than print time estimate 154 for print job 152. Alternatively, overall efficiency 1018 may be below an efficiency threshold 1020 for printing operations at first printing device 104. If step 1118 is no, then flowchart 1100 proceeds to step 1122, disclosed below.

If step 1118 is yes, then step 1120 executes by sending alert 1014 to the operator at first printing device 104 or within printing system 100 that a potential problem exists. The drop in efficiency may indicate that first printing device 104 is experiencing problems related to the delays tracked by the disclosed embodiments. Step 1122 executes by updating print time estimation model 150 with actual production time 910 for print job 152. Thus, the processes of tracking productivity and efficiencies related to actual printing may be used to optimize estimated print times for print jobs within printing system 100.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for tracking productivity of a printing device, the method comprising:
performing printing operations to print a print job at the printing device;
detecting a print engine of the printing device is not printing;
determining a cause of a time delay at the print engine using at least one sensor, wherein the cause of the time delay relates to a component of the printing device;
categorizing the cause of the time delay as an equipment issue or an operator issue based on the component;
processing the print job to complete the printing operations at the printing device;
aggregating a compiled time delay related to an equipment issue and a compiled time delay related to an operator issue;
determining an actual production time for the print job, wherein the actual production time includes the compiled time delay related to an equipment issue and the compiled time delay related to an operator issue;
comparing the actual production time to an estimated production time for the print job; and
alerting an operator based on the comparison.

2. The method of claim 1, further comprising displaying the time delay within a calendar view, wherein the calendar view shows a graphic for the print job.

3. The method of claim 2, wherein the graphic is modified based on the time delay.

4. The method of claim 1, further comprising collecting a total time delay corresponding to the cause within the printing device.

5. The method of claim 4, further comprising assigning a category for the cause and determining the total time delay within the category.

6. The method of claim 1, further comprising determining an efficiency at the printing device based on the compared actual production to the estimated production time for a time period at the printing device.

7. The method of claim 6, further comprising defining an efficiency threshold for the printing device.

8. The method of claim 7, further comprising determining that the efficiency for processing at the printing device falls below the efficiency threshold.

9. The method of claim 8, further comprising alerting the operator that the efficiency for the print device is below the efficiency threshold.

10. The method of claim 1, further comprising receiving the print job at the printing device.

11. The method of claim 10, further comprising estimating the estimated production time for the print job using a neural network system.

12. The method of claim 11, further comprising inputting the actual production time into the neural network system.

13. A method for managing printing operations, the method comprising:
performing printing operations to print a print job at the printing device;
detecting a print engine of the printing device is not printing;
determining a cause of a time delay at the print engine using at least one sensor, wherein the cause of the time delay relates to a component of the printing device;
aggregating the time delay with an actual production time for the print job;
processing the print job to complete the printing operations at the printing device;
determining an efficiency for the print job based on the actual production time to an estimated production time for the print job;
compiling the efficiency for the print job with an overall efficiency for a time period at the printing device;
determining that the overall efficiency for the time period at the printing device falls below an efficiency threshold for the printing device; and
alerting an operator that the overall efficiency for the printing device is below the efficiency threshold.

14. The method of claim 13, further comprising defining the efficiency threshold for the printing device.

15. The method of claim 13, further comprising receiving the print job at the printing device.

16. The method of claim 15, further comprising estimating the estimated production time for the print job using a neural network system.

17. A printing system comprising:
a processor; and
a memory coupled to the processor, wherein the memory includes instructions that, when executed on the processor, configures the printing system to perform the operations of
performing printing operations to print a print job at a printing device;
detecting a print engine of the printing device is not printing;
determining a cause of a time delay at the print engine using at least one sensor, wherein the cause of the time delay relates to a component of the printing device;
categorizing the cause of the time delay as an equipment issue or an operator issue based on the component;
processing the print job to complete the printing operations at the printing device;
aggregating a compiled time delay related to an equipment issue and a compiled time delay related to an operator issue;
determining an actual production time for the print job, wherein the actual production time includes the compiled time delay related to an equipment issue and the compiled time delay related to an operator issue;
comparing the actual production time to an estimated production time for the print job; and
alerting an operator based on the comparison.

18. The printing system of claim 17, wherein the operations further comprise determining an efficiency at the printing device based on the compared actual production to the estimated production time for a time period at the printing device.

19. The printing system of claim 18, wherein the operations further comprise defining an efficiency threshold for the printing device.

20. The printing system of claim 19, wherein the operations further comprise determining that the efficiency for processing at the printing device falls below the efficiency threshold.
